(19) United States
(12) Patent Application Publication
(10) Pub. No.: US 2019/0147854 A1
(43) Pub. Date: May 16, 2019

(54) Speech Recognition Source to Target Domain Adaptation

(71) Applicant: Microsoft Technology Licensing, LLC, Redmond, WA (US)

(72) Inventors: Jinyu Li, Redmond, WA (US); Vadim A. Mazalov, Issaquah, WA (US); Yifan Gong, Sammamish, WA (US); Zhong Meng, Redmond, WA (US); Zhuo Chen, Redmond, WA (US)

(21) Appl. No.: 15/814,910

(22) Filed: Nov. 16, 2017

(51) Int. Cl. G10L 15/14; G10L 15/16; G10L 15/187

(52) U.S. Cl. CPC G10L 15/144; G10L 15/187; G10L 15/16

(57) ABSTRACT

A method includes obtaining a source domain having labels for source domain speech input features, obtaining a target domain having target domain speech input features without labels, extracting private components from each of the source and target domain speech input features, extracting shared components from the source and target domain speech input features using a shared component extractor, and reconstructing the source and target input features as a regularization of private component extraction.

### BACKGROUND

In recent years, advances in deep learning have led to remarkable performance boost in automatic speech recognition (ASR). However, ASR systems still suffer from large performance degradation when acoustic mismatch exists between the training and test conditions. Many factors contribute to the mismatch, such as variation in environment noises, channels and speaker characteristics.

### SUMMARY

A method includes obtaining a source domain having labels for source domain speech input features, obtaining a target domain having target domain speech input features without labels, extracting private components from each of the source and target domain speech input features, extracting shared components from the source and target domain speech input features using a shared component extractor, and reconstructing the source and target input features as a regularization of private component extraction.

A machine readable storage device having instructions for execution by a processor of a machine to cause the processor to perform operations to perform a method of generating a model. The method includes obtaining a source domain having labels for source domain speech input features, obtaining a target domain having target domain speech input features without labels, extracting private components from each of the source and target speech domain input features, extracting shared components from the source and target speech domain input features using a shared component extractor, and reconstructing the source and target input features as a regularization of private component extraction.

A system includes one or more processors and a storage device coupled to the one or more processors having instructions stored thereon to cause the one or more processors to execute speech recognition operations. The operations include receiving an unlabeled input speech frame, using a shared component extractor to extract a shared component from the input speech frame, using a speech unit classifier to identify a speech unit label from the shared component, using a domain classifier to identify a speech unit label from the shared component, using source/target private component extractors to extract source/target private components, and using a reconstructor to reconstruct the original feature, wherein the shared component extractor, speech unit classifier, domain classifier, private component extractors and reconstructor are jointly optimized using stochastic gradient descent to adapt a labeled source domain acoustic model to an unlabeled target speech domain acoustic model to recognize speech from the unlabeled target speech domain.

### BRIEF DESCRIPTION OF THE DRAWINGS

FIG. 1 is a block diagram illustrating a system architecture for training an acoustic model for robust speech recognition according to an example embodiment.

FIG. 2 is a high-level flowchart illustrating a computer implemented method for unsupervised adaptation with the system of FIG. 1 according to an example embodiment.

FIG. 3 is a block flow diagram illustrating an acoustic model to be adapted to the target-domain data, which consists of the components of the domain separation network (DSN) that are used in decoding once adapted according to an example embodiment.

FIG. 4 is a flowchart illustrating the functionalities of different components of a domain separation network that adapts a speech recognition acoustic model of a labeled source speech domain to a speech recognition adapted acoustic model suitable for recognizing speech from an unlabeled target speech domain according to an example embodiment.

FIG. 5 is a flowchart illustrating a method of speech recognition according to an example embodiment.

FIG. 6 is a block diagram of circuitry for example devices to perform methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term. “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

In recent years, advances in deep learning have led to a remarkable performance boost in automatic speech recognition (ASR). However. ASR systems still suffer from large performance degradation when acoustic mismatch exists between the training and test conditions. Many factors contribute to the mismatch, such as variation in environment noises, channels and speaker characteristics. Domain adaptation is an effective way to address this limitation, in which acoustic model parameters or input features are adjusted to compensate for the mismatch.

One difficulty with domain adaptation is that the available data from the target domain is usually limited, in which case the acoustic model can be easily overfitted. To address this issue, regularization-based approaches have been proposed to regularize the neuron output distributions or the model parameters. Transformation-based approaches have also been introduced to reduce the number of learnable parameters. The trainable parameters were further reduced by singular value decomposition of weight matrices of a neural network. Although these methods utilize the limited data from the target domain, they still require labels for the adaptation data and can only be used in supervised adaptation.

Domain adaptation has become an important topic with the rapid increase of the amount of un-transcribed speech data for which human annotation is expensive. One method involved learning the contribution of hidden units by additional amplitude parameters and differential pooling. Another method involved adjusting the linear transformation learned by batch normalized acoustic model. Although these methods lead to increased performance in the ASR task when no labels are available for the adaptation data, the methods still rely on the senone (tri-phone state) alignments against the unlabeled adaptation data through first pass decoding. A senone is a 10-millisecond element of human speech utterance. Speech recognition scientists have identified several thousand senones into which all speech may be divided.

A first pass decoding result is unreliable when the mismatch between the training and test conditions is significant. It is also time-consuming and not feasibly applied to huge amounts of adaptation data. There are even situations when decoding adaptation data is not allowed because of a privacy agreement signed with the speakers. Methods depending on the first pass decoding of the unlabeled adaptation data are sometimes called “semi-supervised” adaptation.

In various embodiments of the present inventive subject matter, pure unsupervised domain adaptation may be performed without any exposure to the labels or the decoding results of the adaptation data in a target domain. Improved automatic speech recognition (ASR) better addresses an acoustic mismatch between training and test conditions in which acoustic model parameters or input features are adjusted to compensate for the mismatch using a domain separation network (DSN) pure unsupervised adaptation framework. The DSN learns an intermediate deep representation that is both senone or phoneme-discriminative and domain-invariant through jointly optimizing the primary task of speech unit classification and the secondary task of domain classification with adversarial objective functions.

A phoneme is the unit corresponding to how a word is pronounced. For example, the word “hello” is decomposed into the phoneme units: hh ax l ow. For English, the number of phoneme units is around 45, depending on how linguists define them. By taking the left and right context, phoneme units can be expanded to triphone units. Then every triphone unit is modeled by three states, and each state is a seone.

The following is an example to show a word is decomposed to phoneme, triphone (taking the context of left and right phoneme), and then senone.
Word sequence: Hey Cortana
Phoneme sequence: hh ey k ao r t ae n ax
Triphone sequence: sil-hh+ey hh-ey+k ey-k+ao k-ao+r ao-r+ae ae-n+ax n-ax+sil
Every triphone is then modeled by a three-state (senone) HMM: sil-hh+ey[1], sil-hh+ey[2], sil-hh+ey[3], hh-ey+k[1], . . . , n-ax+sil[3].

The following description uses the term senone, but may also apply to phonemes and various other speech units in further embodiments.

The DSN may be used in various applications, including for example, adaption of a close-talk acoustic model to unlabeled far-talk speech data. Further applications include the adaption of clean acoustic model to unlabeled noisy speech data, of adult acoustic model to unlabeled children's speech data, of narrow-band acoustic model to unlabeled wide-band speech data, and of original audio acoustic model to unlabeled codec speech data.

Recently, adversarial training has become a very hot topic in deep learning because of its great success in estimating generative models. It was first applied to the area of unsupervised domain adaptation in a form of multi-task leaning. The unsupervised adaptation was achieved by learning deep intermediate representations that are both discriminative for the main task (image classification) on the source domain and invariant with respect to the shift between source and target domains. The domain invariance is achieved by the adversarial training of the domain classification objective functions. This can be easily implemented by augmenting a feed-forward model with a few standard layers and a gradient reversal layer (GRL). This GRL approach may be applied to acoustic models for unsupervised adaptation and for increasing noise robustness. Improved ASR performance is achieved in both scenarios.

However, the GRL method focuses only on learning a domain-invariant shared representation between the source and the target domains, and ignores the unique characteristics of each domain which are also informative. The domain-invariance of the shared representation can be further improved by explicitly modeling what is unique in each domain. DSNs separate the deep representation of each training sample into two parts: one private component that is unique to its domain and one shared component that is invariant to the domain shift.

In the present inventive subject matter, a DSN is used for unsupervised domain adaptation of a DNN-HMM (deep neural network-hidden Markov model) acoustic model for robust speech recognition. A shared component and a private component are estimated for each speech frame. The shared component is learned to be both senone-discriminative and domain-invariant through adversarial multi-task training of a shared component extractor and a domain classifier. The private component is trained to be orthogonal to the shared component to further enhance the domain-invariance of the shared component. A reconstructor DNN is used to reconstruct the original speech feature from the private and shared components, serving for regularization. The method may achieve 11.08% relative word error rate (WER) improvement over the GRL training approach for robust ASR on the CHiME-3 dataset.

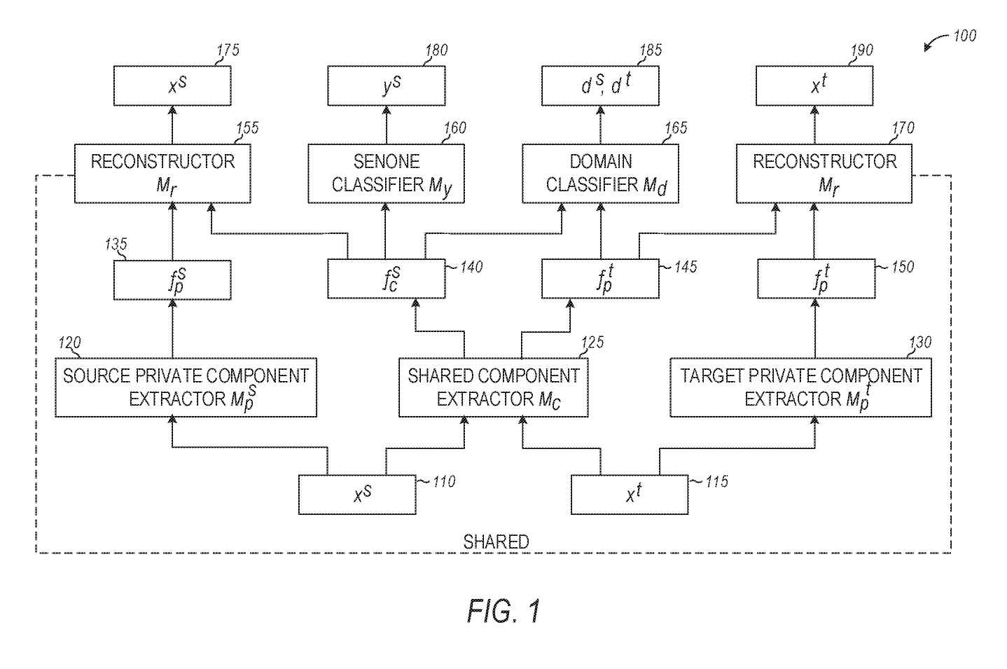

FIG. 1 is a block diagram illustrating a DSN system 100 architecture for training a DNN-HMM acoustic model for robust speech recognition. The acoustic model will consist of a trained shared component extractor 125 and a trained senone classifier 160 as described below and as trained by DSN system 100. Senone classifier 160 may also be used to classify other speech units, such as phonemes and triphone speech units in further embodiments and may also be referred to as a speech unit classifier.

Speech frames from the source domain, x^{s} at 110 and target domain, x^{t} at 115 are inputs to system 100. The speech frames 110 from the source domain are provided to both source private component extractor Mₚ^{s} 120 and a shared component extractor M_{c} 125. The speech frames 115 from the target domain are provided to the shared component extractor M_{c} 125 and to a target private component extractor Mₚ^{t} 130.

The extractors map the speech frames to various private and shared components indicated at fₚ^{s} 135, f_{c}^{s} 140, f_{c}^{t} 145, and fₚ^{t} 150. Note that the superscript of the component labels corresponds to source, s, and target, t, while the subscript refers to private, p, or shared component, c. Thus, source private component extractor Mₚ^{s} 120 maps to component fₚ^{s} 135. Shared component extractor M_{c} 125 maps to shared components f_{c}^{s} 140, f_{c}^{t} 145. Target private component extractor Mₚ^{t} 130 maps to component fₚ^{t} 150.

A next level of DSN system 100 architecture includes a reconstructor Mᵣ 155, which takes the extracted private and shared source components fₚ^{s} 135 and f_{c}^{s} 140 respectively, concatenates them, and reconstructs the source domain speech frame as shown at xₛ 175. Also included is a speech unit or senone classifier M_{y}, taking component f_{c}^{s} 140 to generate a correct speech unit or senone label yₛ 180. A domain classifier M_{d} 165 identifies the proper domains dₛ and dᵣ at 185 using both shared components f_{c}^{s} 140 and f_{c}^{t} 145. The reconstructor Mᵣ, duplicated at 170 uses the private and shared target components fₚ^{t} 150 and f_{c}^{t} 145 respectively and reconstructs the target domain speech frame as shown at xₜ 190.

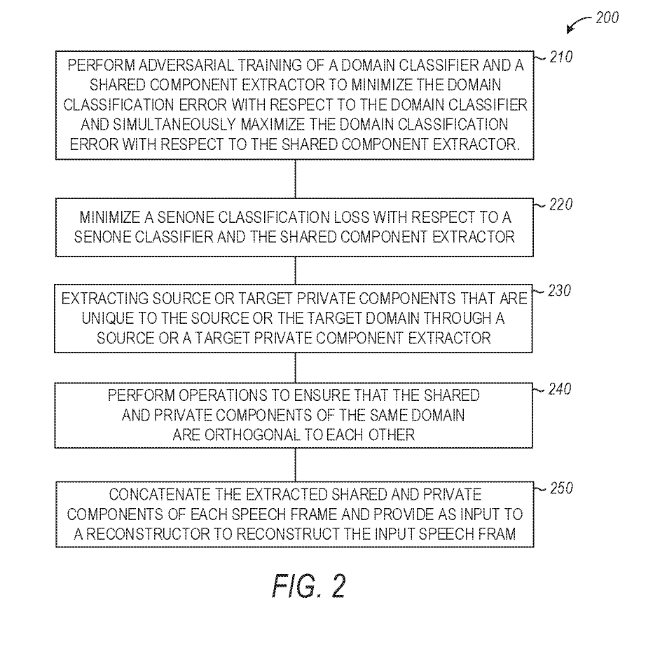

FIG. 2 is a high-level flowchart illustrating a computer implemented method 200 for unsupervised adaptation with DSN system 100. At 210, operations are executed to perform adversarial training of the domain classifier DNN 165 that maps the shared components to its domain label 185 and the shared component extractor 125 to minimize the domain classification error with respect to the domain classifier 165 while simultaneously maximizing the domain classification error with respect to the shared component extractor 125.

Operations are performed at 220 to minimize the speech unit or senone classification loss with respect to the senone classifier 160 and the shared component extractor 125 given the shared component from the source domain to ensure its speech unit or senone-discriminativeness.

At 230, operations are performed for the source or the target domain, by extracting the source or the target private components that are unique to the source or the target domain through a source or a target private component extractor 120 and 130 respectively.

At 240, operations are performed such that the shared and private components of the same domain are trained to be orthogonal to each other to further enhance the degree of domain-invariance of the shared components.

The extracted shared and private components of each speech frame are concatenated and fed as the input of a reconstructor to reconstruct the input speech frame via operations performed at 250.

Further detail regarding the operation of DNS system 100 architecture is now described. In the pure unsupervised domain adaptation task, the system 100 only has access to a sequence of speech frames X^{s}={x₁^{s}, . . . , x_{N}_{ₛ}^{s}} from the source domain distribution, a sequence of senone labels Y^{s}={y₁^{s}, . . . , y_{N}_{ₛ}^{s}}, aligned with source data X^{s} and a sequence of speech frames X^{t}={x₁^{t}, . . . , x_{N}_{ₛ}^{t}} from a target domain distribution. Senone labels or other types of transcription may not be available for the target speech sequence X^{t}.

When applying domain separation networks (DSNs) to the unsupervised adaptation task, the goal is to learn the shared (or common) component extractor 125 DNN M_{c} that maps an input speech frame x^{s} from source domain or x^{t} from target domain to a domain-invariant shared component f_{c}^{s} 140 or f_{c}^{t} 145 respectively. At the same time, learn the senone classifier DNN M_{c} 160 that maps the shared component f_{c}^{s} 140 from the source domain to the correct senone label y^{s} 180.

To achieve this, adversarial training of the domain classifier DNN M_{d} 165 that maps the shared component f_{c}^{s} 140 or f_{c}^{t} 145 to its domain label d^{s} or d^{t} at 185 and the shared component extractor that maps X^{s} or X^{t} to f_{c}^{s} 140 or f_{c}^{t} 145 is performed, while simultaneously minimizing the senone classification loss of M_{y} 160 given shared component f_{c}^{s} 140 from the source domain to ensure the senone discriminativeness of f_{c}^{s} 140.

For the source or the target domain, the source or the target private component fₚ^{s} 135 or fₚ^{t} 150 is extracted that is unique to the source or the target domain through a source or a target private component extractor Mₚ^{s} 120 or Mₚ^{t} 130. The shared and private components of the same domain are trained to be orthogonal to each other to further enhance the degree of domain-invariance of the shared components. The extracted shared and private components of each speech frame are concatenated and fed as the input of a reconstructor Mᵣ 155, 170 to reconstruct the input speech frame x^{s} 175 or x^{t} 190.

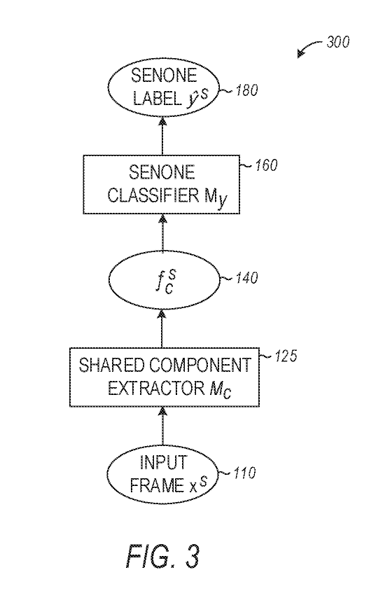

FIG. 3 is a block flow diagram illustrating an adapted acoustic model 200 to be adapted to the target-domain data, which consists of the components of the domain separation network (DSN) that are used in decoding once adapted. Reference numbers are the same for the same components as in FIG. 1. In one embodiment, all the sub-networks may be jointly optimized using stochastic gradient descent (SGD). The optimized shared component extractor M_{c} 125 and senone classifier M_{y} 160 form an adapted acoustic model 200 for subsequent robust speech recognition.

The shared component extractor M 125 and senone predictor or classifier 160 of the adapted acoustic model 20X) are initialized from a DNN-HMM acoustic model. The DNN-HMM acoustic model is trained with labeled speech data (X^{s}, Y^{s}) from the source domain. The senone-level alignment Yₛ is generated by a well-trained GMM (Gaussian mixture model)-HMM system.

Each output unit of the DNN adapted acoustic model 200 corresponds to one of the senones q in a set Q. The output unit for senone q E Q is the posterior probability p(q|xₙ^{s}) obtained by a softmax function.

Shared component extraction may be trained with adversarial training in one embodiment. The well-trained adapted acoustic model 200 can be decomposed into two parts: a share component extractor M 125 with parameters θ_{c} and a senone classifier M_{y} 160 with parameters θ_{y}. An input speech frame from source domain x^{s} 110 is first mapped by the M_{c} 125 to a K-dimensional shared component 140 f_{c}^{s}∈R^{K}, f_{c}^{s} 140 is then mapped to the senone label posteriors by a senone classifier M_{y} 160 with parameters θ_{y} as follows.

M_{y}(f_{c}^{s})=M_{y}(M_{c}(xᵢ^{s})=p(ŷₙ^{s}=q|xᵢ^{s}lθ_{c}θ_{y}) (1)

where ŷᵢ^{s} denotes the predicted senone label for source frame xᵢ^{s} and q∈Q.

The domain classifier DNN M_{d} 165 with parameters θ_{d} takes the shared component from source domain f_{c}^{s} or target domain f_{c}^{t} as the input to predict the two-dimensional domain label posteriors as follows (the 1st and 2nd output units stand for the source and target domains respectively).

M_{d}(M_{c}(xᵢ^{s}))=p(\hat{d}ᵢ^{s}=a|xᵢ^{s};θ_{c},θ_{d}),a∈{1,2} (2)

M_{d}(M_{c}(xⱼ^{t}))=p(\hat{d}ᵢ^{t}=a|xⱼ^{t};θ_{c},θ_{d}),a∈{1,2} (3)

where \hat{d}ᵢ^{s} and \hat{d}ᵢ^{t} denote the predicted domain labels for the source frame xᵢ^{s} and the target frame xⱼ^{t} respectively.

In order to adapt the source domain acoustic model (i.e., M_{c} 125 and M_{y} 160) to the unlabeled data from target domain, the distribution of the source domain shared component P(f_{c}^{s})=P(M_{c}(x^{s})) is made as close to that of the target domain P(f_{c}^{t})=P(M_{c}(x^{t})) as possible. In other words, the shared component should be made domain-invariant. This can be realized by adversarial training, in which the parameters & of shared component extractor are adjusted to maximize the loss of the domain classifier M_{d} 165 [symbol] _{domain}^{c}(θ_{c}) below while adjusting the parameters θ_{d} to minimize the loss of the domain classifier L_{domain}^{d}(θ_{d}) below.

$$\begin{matrix}{ℒ}_{domain}^{d} ( {θ}_{d} ) = - {\sum }_{i}^{{N}_{s}} log p ( {\hat{d}}_{i}^{s} = 1 \vert {x}_{i}^{s} ; {θ}_{d} ) - {\sum }_{j}^{{N}_{t}} log p ( {\hat{d}}_{i}^{t} = 2 \vert {x}_{j}^{t} ; {θ}_{d} ) & ( 4 ) \\ {ℒ}_{domain}^{c} ( {θ}_{c} ) = - {\sum }_{i}^{{N}_{s}} log p ( {\hat{d}}_{i}^{s} = 1 \vert {x}_{i}^{s} ; {θ}_{c} ) - {\sum }_{j}^{{N}_{t}} log p ( {\hat{d}}_{i}^{t} = 2 \vert {x}_{j}^{t} ; {θ}_{c} ) & ( 5 )\end{matrix}$$

This minimax competition will first increase the capability of both the shared component extractor M_{c} 125 and the domain classifier M_{d} 165 and will eventually converge to the point where the shared component extractor Me 125 generates extremely confusing representations that domain classifier M_{d} 165 is unable to distinguish (i.e., domain-invariant).

Simultaneously, the loss of the senone classifier M_{y} 160 below is minimized to ensure the domain-invariant shared component f_{c}^{s} is also discriminative to senones.

$${ℒ}_{senone} ( {θ}_{c} , {θ}_{s} ) = - {\sum }_{i}^{{N}_{s}} log p ( {y}_{i}^{s} \vert {x}_{i}^{s} ; {θ}_{s} , {θ}_{c} ) \qquad ( 6 )$$

Since the adversarial training of the domain classifier M_{d} 165 and shared component extractor M_{c} 125 has made the distribution of the target domain shared-component f_{c}^{t} 145 as close to that of f_{c}^{s} 140 as possible, the f_{c}^{t} 145 is also senone-discriminative and will lead to minimized senone classification error given optimized M_{y}. Because of the domain-invariant property, good adaptation performance can be achieved when the target domain data goes through the network.

To further increase the degree of domain-invariance of the shared components, the private component that is unique to each domain is modeled by a private component extractor DNN Mₚ parameterized by θₚ. Mₚ^{s} and Mₚ^{t} map the source frame x^{s} and the target frame x^{t} to hidden representations fₚ^{s}=Mₚ^{s} (x^{s}) and fₚ^{t}=Mₚ^{t}(x^{t}) which are the private components of the source and target domains respectively. The private component for each domain is trained to be orthogonal to the shared component by minimizing the difference loss below.

$${ℒ}_{diff} ( {θ}_{c} , {θ}_{p}^{s} , {θ}_{p}^{t} ) = {‖ {\sum }_{i}^{{N}_{s}} {M}_{c} ( {x}_{i}^{s} ) {{M}_{p}^{s} ( {x}_{i}^{s} )}^{⊤} ‖}_{F}^{2} + {‖ {\sum }_{j}^{{N}_{t}} {M}_{c} ( {x}_{j}^{t} ) {{M}_{p}^{t} ( {x}_{j}^{t} )}^{⊤} ‖}_{F}^{2} \qquad ( 7 )$$

where ∥.∥_{F}² is the squared Frobenius norm. All the vectors are assumed to be column-wise.

As a regularization term, the predicted shared and private components are then concatenated and fed into a reconstructor DNN M 155, 170 with parameters 61 to recover the input speech frames x^{s} and x^{t} from both source and target domains respectively. The reconstructor 155, 170 is trained to minimize the mean square error based reconstruction loss as follows:

$$\begin{matrix}{ℒ}_{recon} ( {θ}_{c} , {θ}_{p}^{s} , {θ}_{p}^{t} , {θ}_{r} ) = {\sum }_{i}^{{N}_{s}} {‖ {\hat{x}}_{i}^{s} - {x}_{i}^{s} ‖}_{2}^{2} + {\sum }_{j}^{{N}_{t}} {‖ {\hat{x}}_{j}^{t} - {x}_{j}^{t} ‖}_{2}^{2} & ( 8 ) \\ {\hat{x}}_{i}^{s} = {M}_{r} ( [ {M}_{c} ( {x}_{i}^{s} ) , {M}_{p}^{s} ( {x}_{i}^{s} ) ] ) & ( 9 ) \\ {\hat{x}}_{j}^{t} = {M}_{r} ( [ {M}_{c} ( {x}_{j}^{t} ) , {M}_{p}^{t} ( {x}_{j}^{t} ) ] ) & ( 10 )\end{matrix}$$

where [.,.] denotes concatenation of two vectors.

The total loss of DSN is formulated as follows and is jointly optimized with respect to the parameters.

$$\begin{matrix}{ℒ}_{total} ( {θ}_{y} , {θ}_{c} , {θ}_{d} , {θ}_{p}^{s} , {θ}_{p}^{t} , {θ}_{r} ) = {ℒ}_{senone} ( {θ}_{c} , {θ}_{y} ) + {ℒ}_{domain}^{d} ( {θ}_{d} ) - α {ℒ}_{domain}^{c} ( {θ}_{c} ) + β {ℒ}_{diff} ( {θ}_{c} , {θ}_{p}^{s} , {θ}_{p}^{t} ) + γ {ℒ}_{recon} ( {θ}_{c} , {θ}_{p}^{s} , {θ}_{p}^{t} , {θ}_{r} ) & ( 11 ) \\ {min}_{{θ}_{y} , {θ}_{c} , {θ}_{d} , {θ}_{p}^{s} , {θ}_{p}^{t} , {θ}_{r}} {ℒ}_{total} ( {θ}_{y} , {θ}_{c} , {θ}_{d} , {θ}_{p}^{s} , {θ}_{p}^{t} , {θ}_{r} ) & ( 12 )\end{matrix}$$

All the parameters of DSN are jointly optimized through backprogation with stochastic gradient descent (SGD) as follows:

$$\begin{matrix}{θ}_{c} ← {θ}_{c} - μ [ \frac{\partial {ℒ}_{senone}}{\partial {θ}_{c}} - α \frac{\partial {ℒ}_{domain}^{c}}{\partial {θ}_{c}} + β \frac{\partial {ℒ}_{diff}}{\partial {θ}_{c}} + γ \frac{\partial {ℒ}_{recon}}{\partial {θ}_{c}} ] & ( 13 ) \\ {θ}_{d} ← {θ}_{d} - μ \frac{\partial {ℒ}_{domain}^{d}}{\partial {θ}_{d}} , {θ}_{y} ← {θ}_{y} - μ \frac{\partial {ℒ}_{senone}}{\partial {θ}_{y}} & ( 14 ) \\ {θ}_{p}^{s} ← {θ}_{p}^{s} - μ [ β \frac{\partial {ℒ}_{diff}}{\partial {θ}_{p}^{s}} + γ \frac{\partial {ℒ}_{recon}}{\partial {θ}_{p}^{s}} ] & ( 15 ) \\ {θ}_{p}^{t} ← {θ}_{p}^{t} - μ [ β \frac{\partial {ℒ}_{diff}}{\partial {θ}_{p}^{t}} + γ \frac{\partial {ℒ}_{recon}}{\partial {θ}_{p}^{t}} ] & ( 16 ) \\ {θ}_{r} ← {θ}_{r} - μ \frac{\partial {ℒ}_{recon}}{\partial {θ}_{r}} & ( 17 )\end{matrix}$$

Note that the negative coefficient −α in Eq. (13) induces reversed gradient that maximizes the domain classification loss in Eq. (5) and makes the shared components domain-invariant. Without the reversal gradient, SGD would make representations different across domains in order to minimize Eq. (4). For easy implementation, GRL is introduced in [14], which acts as an identity transform in the forward pass and multiplies the gradient by −α during the backward pass.

The optimized shared component extractor M_{c} and senone classifier M_{y} form the adapted acoustic model for robust speech recognition.

In one example, a pure unsupervised environment adaptation of the DNN-HMM acoustic model with domain separation networks for robust speech recognition on the CHiME-3 dataset may be performed. The CHiME-3 dataset was released with the 3rd CHiME speech Separation and Recognition Challenge, which incorporates selected Wall Street Journal corpus sentences spoken or uttered in challenging noisy environments, recorded using a 6-channel tablet based microphone array. CHiME-3 dataset consists of both real and simulated data. The real speech data was recorded in four real noisy environments (on buses (BUS), in caffs (CAF), in pedestrian areas (PED), and at street junctions (STR)). To generate the simulated data, the clean speech is first convoluted with the estimated impulse response of the environment and then mixed with the background noise separately recorded in that environment. The noisy training data consists of 1600 real noisy utterances from 4 speakers, and 7138 simulated noisy utterances from 83 speakers in the WSJ0 SI-84 training set recorded in 4 noisy environments. There are 3280 utterances in the development set including 410 real and 410 simulated utterances for each of the 4 environments. There are 2640 utterances in the test set including 330 real and 330 simulated utterances for each of the 4 environments. The speakers in training set, development set and the test set are mutually different (i.e., 12 different speakers in the CHiME-3 dataset). The training, development and test data sets are all recorded in 6 different channels.

8738 clean utterances corresponding to the 8738 noisy training utterances in the CHiME-3 dataset are selected from the WSJ0 SI-85 training set to form the clean training data in our experiments. WSJ 5K word 3-gram language model is used for decoding.

In a baseline system, a DNN-HMM acoustic model with clean speech may be trained and then adapted to noisy data using GRL unsupervised adaptation. Hence, the source domain is with clean speech while the target domain is with noisy speech.

A 29-dimensional log Mel filterbank features together with 1st and 2nd order delta features (totally 87-dimensional) for both the clean and noisy utterances may be extracted by an HTK Toolkit. Each frame may be spliced together with 5 left and 5 right context frames to form a 957-dimensional feature. The spliced features are fed as the input of the feed-forward DNN after global mean and variance normalization. The DNN has 7 hidden layers with 2048 hidden units for each layer. The output layer of the DNN has 3012 output units corresponding to 3012 senone labels. Senone-level forced alignment of the clean data is generated using a GMM-HMM system. The DNN is first trained with 8738 clean training utterances in CHiME-3 and the alignment to minimize the cross-entropy loss and then tested with simulation and real development data of CHiME-3.

After training with clean data, the DNN is then adapted to the 8738 noisy utterances from Channel 5 using GRL method. No senone alignment of the noisy adaptation data is used for the unsupervised adaptation. The feature extractor is initialized with the first 4 hidden layers of the clean DNN and the genone classifier is initialized with the last 3 hidden layers plus the output layers of the clean DNN. The domain classifier is a feedforward DNN with two hidden layers and each hidden layer has 512 hidden units. The output layer of the domain classifier has 2 output units representing source and target domains. The 2048 hidden units of the 4th hidden layer of the DNN acoustic model is fed as the input to the domain classifier. A GRL is inserted in between the deep representation and the domain classifier for easy implementation. The GRL adapted system is tested on real and simulation noisy development data in CHiME-3 dataset.

The clean DNN acoustic model is adapted to the 8738 noisy utterances using DSN. No senone alignment of the noisy adaptation data is used for the unsupervised adaptation. The DSN may be implemented with a (Computation Network Toolkit) CNTK 2.0 Toolkit as described in Yu. Dong, et al. “An introduction to computational networks and the computational network toolkit.” Microsoft Technical Report MSR-TR-2014-112 (2014). The shared component extractor M is initialized with the first Nₕ hidden layers of the clean DNN and the senone classifier M_{y} is initialized with the last (7−Nₕ) hidden layers plus the output layer of the clean DNN. Nₕ indicates the position of shared component in the DNN acoustic model and ranges from 3 to 7 in some experiments. The domain classifier M_{d} of the DSN may have exactly the same architecture as that of the GRL.

The private component extractors Mₚ^{s} and Mₚ^{t} for the clean and noisy domains are both feedforward DNNs with 3 hidden layers and each hidden layer has 512 hidden units. The output layers of both Mₚ^{s} and Mₚ^{t} have 2048 output units. The reconstructor Mᵣ is a feedforward DNN with 3 hidden layers and each hidden layer has 512 hidden units. The output layer of the Mᵣ has 957 output units with no non-linear activation functions to reconstruct the spliced input features.

The activation functions for the hidden units of Me is sigmoid. The activation functions for hidden units of Mₚ^{s}, Mₚ^{t}, M_{d} and Mᵣ are rectified linear units (ReLU). The activation functions for the output units of M and M_{d} are softmax. The activation functions for the output units of Mₚ^{s}, Mₚ^{t} are sigmoid. All the sub-networks except for M_{y} and Mᵣ are randomly initialized. The learning rate is fixed at 5×10⁻¹ throughout the experiments. The adapted DSN is tested on real and simulation development data in CHiME-3 Dataset.

TABLE 1
Result Analysis

| System | Data | BUS | CAF | PED | STR | Avg. |
|---|---|---|---|---|---|---|
| Clean | Real | 36.25 | 31.78 | 22.76 | 27.18 | 29.44 |
| | Simu | 26.89 | 37.74 | 24.38 | 26.76 | 28.94 |
| GRL | Real | 35.93 | 28.24 | 19.58 | 25.16 | 27.16 |
| | Simu | 26.14 | 34.68 | 22.01 | 25.83 | 27.16 |
| DSN | Real | 32.62 | 23.48 | 17.29 | 23.46 | 24.15 |
| | Simu | 23.38 | 30.39 | 19.51 | 22.01 | 23.82 |

Table 1 shows word error rates (WER) expressed as a percentage (%) for performance of unadapted acoustic model, GRL and DSN adapted DNN acoustic models for robust ASR real and simulated development sets of CHiME-3.

Table 1 shows the WER performance of clean, GRL adapted and DSN adapted DNN acoustic models for ASR. The clean DNN achieves 29.44% and 28.25% WERs on the real and simulated development data respectively. The GRL adapted acoustic model achieves 27.16% and 27.16% WERs on the real and simulated development data. The best WER performance for DSN adapted acoustic model are 24.15% and 23.82% on real and simulated development data, which achieve 11.08% and 12.30% relative improvement over the GRL baseline system and achieve 17.97% and 17.69% relative improvement over the unadapted acoustic model. The best WERs are achieved when Nₕ=7 and α=8.0.

We investigate the impact of shared component position Nₕ and the reversal gradient coefficient α on the WER performance as in Table 2. We observe that the WER decreases with the growth of Nₕ, which is reasonable as the higher hidden representation of a well-trained DNN acoustic model is inherently more senone-discriminative and domain-invariant than the lower layers and can serve as a better initialization for the DSN unsupervised adaptation.

Domain separation networks successfully adapt a clean acoustic model to the unlabeled noisy data and achieves remarkable WER improvement over GRL unsupervised adaptation method on robust ASR. The shared component between source and target domains extracted by DSN through adversarial training are both domain-invariant and senone-discriminative. The extraction of private component that is unique to each domain significantly improves the degree of domain-invariance and the ASR performance.

TABLE 2

| | Reversal Gradient Coefficient α | | | | | | | | | |
|---|---|---|---|---|---|---|---|---|---|---|
| Nₕ | 1.0 | 2.0 | 3.0 | 4.0 | 5.0 | 6.0 | 7.0 | 8.0 | 9.0 | Avg. |
| 3 | 27.20 | 26.24 | 25.76 | 26.51 | 26.12 | 26.92 | 26.65 | 26.91 | 27.74 | 26.56 |
| 4 | 26.56 | 26.08 | 25.75 | 25.99 | 25.88 | 26.76 | 27.00 | 27.13 | 27.74 | 26.54 |
| 5 | 26.53 | 25.90 | 26.07 | 25.88 | 25.72 | 26.17 | 27.06 | 26.67 | 27.37 | 26.37 |
| 6 | 25.77 | 25.17 | 25.06 | 24.94 | 24.6 | 25.13 | 25.53 | 25.42 | 25.73 | 25.26 |
| 7 | 25.99 | 25.14 | 24.73 | 24.43 | 24.69 | 24.53 | 24.42 | 24.15 | 24.29 | 24.71 |

Table 2 illustrates ASR WERs (%) for the DSN adapted acoustic models with respect to Nₕ reversal gradient coefficient α on the real development set of CHIME-3.

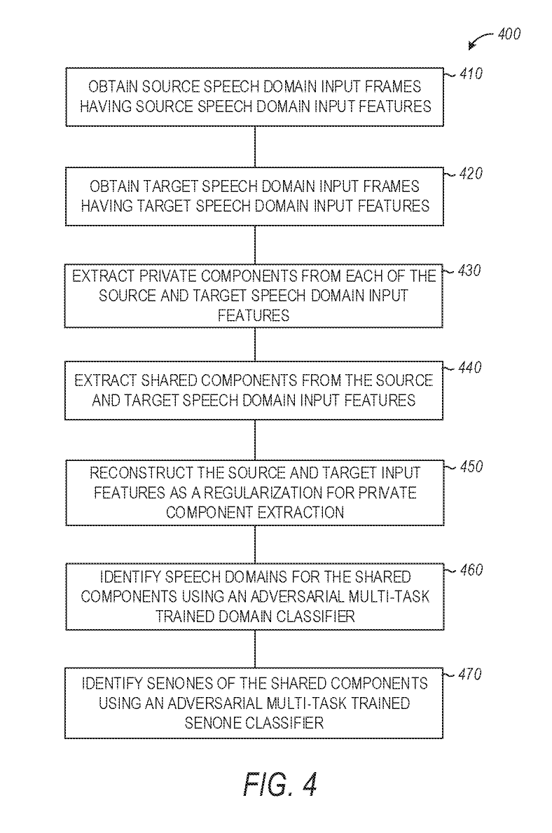

FIG. 4 is a flowchart describing operations or functionalities of different components of the DSN for execution on one or more processors to perform an example method 400 of adapting a speech recognition acoustic model of a labeled source speech domain to a speech recognition adapted acoustic model suitable for recognizing speech from an unlabeled target speech domain. As mentioned above, one example of a source speech domain is speech in a quiet environment, which the target speech domain used to train the adapted acoustic model is the same utterances/speech in a noisy environment.

Method 400 may begin at operation 410 by obtaining a source speech domain having labels for source speech domain input features. At 420, operations are performed to obtain a target speech domain having target speech domain input features without labels. The input features of both domains may be obtained in the form of input frames in one embodiment. Operations at 430 are performed to extract private components from each of the source and target speech domain input features.

At 440, operations are performed to extract shared components from the source and target speech domain input features using a shared component extractor. The source and target input features are reconstructed via operations at 450, and together with the entire training process creates a source speech domain to target speech domain adapted acoustic model suitable for speech recognition of speech from the target speech domain. The reconstruction serves as a regularization for private component extraction by minimizing the mean square error rate of the reconstruction loss as described above.

In one embodiment, the acoustic model includes the shared component extractor and a senone classifier to extract senones from the shared components from the source domain input features. The shared component extractor and senone classifier may be initialized from a DNN-HMM acoustic model. The acoustic model may be trained with labeled speech data (X^{s}, Y^{s}) from the source speech domain where X^{s}, are speech frames and Y^{s} are senone labels. An output unit of the acoustic model corresponds to a senone q in a set Q.

In one embodiment, method 400 further includes operations 460 to identify speech domains for the shared components using an adversarial multi-task trained domain classifier, and identify via operations 470 senones of the shared components using an adversarial multi-task trained senone classifier. We minimize the domain classification error with respect to the shared component extractor while maximizing it with respect to the shared component extractor. The shared components are orthogonal to the private components of the source and target input features.

The source speech domain may include speech in a first context and the target speech domain comprises the same speech in a different context. Examples may include a close-talk context as the source and a far-talk context as the target. Further applications include the adaption of a clean acoustic model to unlabeled noisy speech data, of adult acoustic model to unlabeled children's speech data, of narrow-band acoustic model to unlabeled wide-band speech data, and of original audio acoustic model to unlabeled codec speech data.

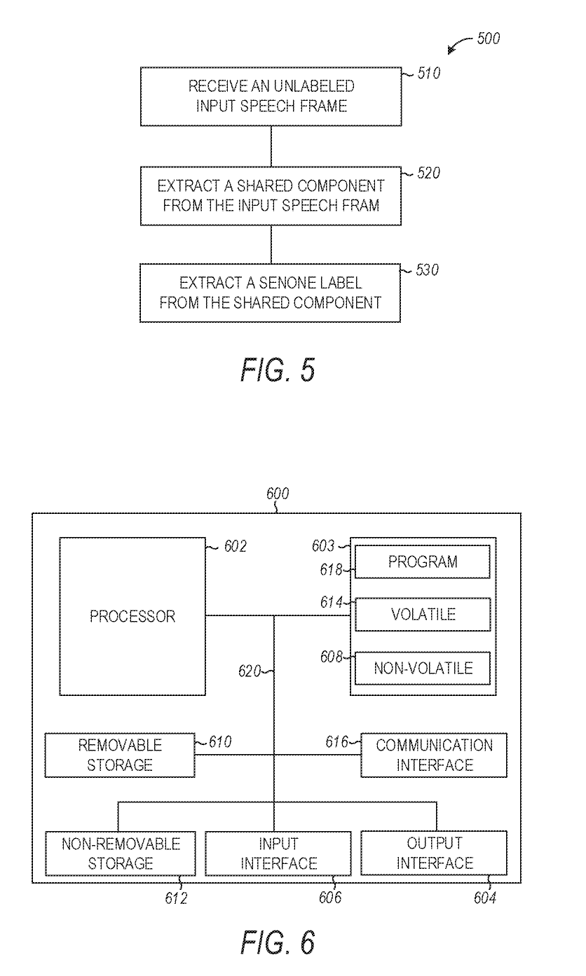

In one embodiment, system 100 includes one or more processors, such as processing resources that execute instructions stored on a storage device to perform a method 500 of speech recognition as shown in flowchart form in FIG. 5.

Method 500 begins at 510 where operations are performed to receive an unlabeled input speech frame. Operations 520 use a shared component extractor to extract a shared component from the input speech frame. At operations 530, a senone classifier is used to extract a senone label from the shared component. The shared component extractor and senone classifier are jointly optimized in one embodiment using stochastic gradient descent to adapt a labeled source domain acoustic model to an unlabeled target speech domain acoustic model to recognize speech from the unlabeled target speech domain. The shared component extractor may be made domain-invariant by minimizing a first domain classification error with respect to the shared component extractor while maximizing a second domain classification error with respect to the shared component extractor.

In one embodiment, the shared component extractor and senone classifier are initialized from a DNN-HMM acoustic model and are trained with labeled speech data (X^{s}, Y^{s}) from the source speech domain where X^{s}, are speech frames and Y^{s} are senone labels. Via such training, the shared component extractor and senone classifier form an adapted trained domain invariant acoustic model.

FIG. 6 is a block schematic diagram of a computer system 600 to implement a training system to adapt acoustic speech models between source and target domains and to perform speech recognition using such adapted acoustic speech models, as well as other devices for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment. Further, although the various data storage elements are illustrated as part of the computer 600, the storage may also or alternatively include cloud-based storage accessible via a network, such as the Internet or server based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM). Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software that, when executed by the processing unit 602, performs network switch operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 618 may be used to cause processing unit 602 to perform one or more methods or algorithms described herein.

### EXAMPLES

In example 1, a method includes obtaining a source domain having labels for source domain speech input features, obtaining a target domain having target domain speech input features without labels, extracting private components from each of the source and target domain speech input features, extracting shared components from the source and target domain speech input features using a shared component extractor, and reconstructing the source and target input features as a regularization of private component extraction.

Example 2 includes the method of example 1 wherein the acoustic model includes the shared component extractor and a speech unit classifier to predict senones or phonemes from the shared components extracted from the source domain input features.

Example 3 includes the method of example 2 wherein the shared component extractor and speech unit classifier are initialized from a DNN-HMM acoustic model.

Example 4 includes the method of example 3 wherein the acoustic model is trained with labeled speech data (X^{s}, Y^{s}) from the source domain where X^{s}, are speech frames and Y^{s} are senone labels.

Example 5 includes the method of any of examples 1-4 wherein an output unit of an acoustic model that includes the shared component extractor corresponds to a speech unit q in a set Q.

Example 6 includes the method of any of examples 1-5 and further including identifying speech domains for the shared components using an adversarial multi-task trained domain classifier, and identifying senones or phonemes of the shared components using an adversarial multi-task trained speech unit classifier.

Example 7 includes the method of example 6 wherein the domain classifier and the shared component extractor are jointly trained to minimize a domain classification error with respect to the domain classifier while maximizing the domain classification error with respect to the shared component extractor.

Example 8 includes the method of any of examples 1-7 wherein the shared components are orthogonal to the private components of the source and target input features.

Example 9 includes the method of any of examples 1-8 wherein the source domain comprises utterances in a first context and the target domain comprises utterances spoken in a different context.

In example 10, a machine readable storage device has instructions for execution by a processor of a machine to cause the processor to perform operations to perform a method of generating a model. The method includes obtaining a source domain having labels for source domain speech input features, obtaining a target domain having target domain speech input features without labels, extracting private components from each of the source and target speech domain input features, extracting shared components from the source and target speech domain input features using a shared component extractor, and reconstructing the source and target input features as a regularization of private component extraction.

Example 11 includes the machine readable storage device of example 10 wherein an acoustic model comprises shared component extractor that extracts the shared components from the source and target input features and a speech unit classifier.

Example 12 includes the machine readable storage device of example 11 wherein the shared component extractor and speech unit classifier are initialized from a DNN-HMM acoustic model.

Example 13 includes the machine readable storage device of example 12 wherein the acoustic model is trained with labeled speech data (X^{e}, Y^{s}) from the source domain where X^{s} are speech frames and Y^{s} are speech unit labels.

Example 14 includes the machine readable storage device of any of examples 10-13 wherein an output unit of an acoustic model that includes the shared component extractor corresponds to a speech unit q in a set Q.

Example 15 includes the machine readable storage device of any of examples 10-14 and further including identifying speech domains for the shared components using an adversarial multi-task trained domain classifier, and identifying senones or phonemes of the shared components using an adversarial multi-task trained speech unit classifier.

Example 16 includes the machine readable storage device of example 15 wherein the domain classifier and shared component extractors are jointly trained to minimize a domain classification error with respect to the domain classifier while maximizing the domain classification error with respect to the shared component extractor.

In example 17 system includes one or more processors and a storage device coupled to the one or more processors having instructions stored thereon to cause the one or more processors to execute speech recognition operations. The operations include receiving an unlabeled input speech frame, using a shared component extractor to extract a shared component from the input speech frame, using a speech unit classifier to identify a speech unit label from the shared component, using a domain classifier to identify a speech unit label from the shared component, using source/target private component extractors to extract source/target private components, and using a reconstructor to reconstruct the original feature, wherein the shared component extractor, speech unit classifier, domain classifier, private component extractors and reconstructor are jointly optimized using stochastic gradient descent to adapt a labeled source domain acoustic model to an unlabeled target speech domain acoustic model to recognize speech from the unlabeled target speech domain.

Example 18 includes the system of example 17 wherein the shared component is made domain-invariant and speech unit discriminative.

Example 19 includes the system of example 18 wherein the shared component is made domain-invariant by minimizing a domain classification error with respect to the domain classifier while maximizing the domain classification error with respect to the shared component extractor.

Example 20 includes the system of any of examples 17-18 wherein the shared component extractor and speech unit classifier are initialized from a DNN-HMM acoustic model, the domain classifier, private component extractors and reconstructor and are jointly trained with labeled speech data (X^{s}, Y^{s}) from the source speech domain where X^{s} are speech frames and Y^{s} are speech unit labels, unlabeled speech data from target speech domain and domain labels from both source and target domains, such that the shared component extractor and speech unit classifier form an adapted trained domain invariant acoustic model.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
obtaining a source domain having labels for source domain speech input features;
obtaining a target domain having target domain speech input features without labels;
extracting private components from each of the source and target domain speech input features;
extracting shared components from the source and target domain speech input features using a shared component extractor; and
reconstructing the source and target input features as a regularization of private component extraction.

2. The method of claim 1 wherein an acoustic model includes the shared component extractor and a speech unit classifier to predict senones or phonemes from the shared components extracted from the source domain input features.

3. The method of claim 2 wherein the shared component extractor and speech unit classifier are initialized from a DNN-HMM acoustic model.

4. The method of claim 3 wherein the acoustic model is trained with labeled speech data (X^{s}, Y^{s}) from the source domain where X^{s}, are speech frames and Y^{s} are senone labels.

5. The method of claim 1 wherein an output unit of an acoustic model that includes the shared component extractor corresponds to a senone or phoneme q in a set Q.

6. The method of claim 1 and further comprising:
identifying speech domains for the shared components using an adversarial multi-task trained domain classifier, and
identifying senones or phonemes of the shared components using an adversarial multi-task trained speech unit classifier.

7. The method of claim 6 wherein the domain classifier and the shared component extractor are jointly trained to minimize a domain classification error with respect to the domain classifier while maximizing the domain classification error with respect to the shared component extractor.

8. The method of claim 1 wherein the shared components are orthogonal to the private components of the source and target input features.

9. The method of claim 1 wherein the source domain comprises utterances in a first context and the target domain comprises utterances spoken in a different context.

10. A machine readable storage device having instructions for execution by a processor of a machine to cause the processor to perform operations to perform a method of generating a model, the method comprising:
obtaining a source domain having labels for source domain speech input features;
obtaining a target domain having target domain speech input features without labels;
extracting private components from each of the source and target speech domain input features;
extracting shared components from the source and target speech domain input features using a shared component extractor; and
reconstructing the source and target input features as a regularization of private component extraction.

11. The machine readable storage device of claim 10 wherein an acoustic model comprises shared component extractor that extracts the shared components from the source and target input features and a speech unit classifier.

12. The machine readable storage device of claim 11 wherein the shared component extractor and speech unit classifier are initialized from a DNN-HMM acoustic model.

13. The machine readable storage device of claim 12 wherein the acoustic model is trained with labeled speech data (X^{s}, Y^{s}) from the source domain where X^{s}, are speech frames and Y^{s} are senone or phoneme labels.

14. The machine readable storage device of claim 10 wherein an output unit of an acoustic model that includes the shared component extractor corresponds to a senone or phoneme q in a set Q.

15. The machine readable storage device of claim 10 and further comprising:
identifying speech domains for the shared components using an adversarial multi-task trained domain classifier, and
identifying senones or phonemes of the shared components using an adversarial multi-task trained speech unit classifier.

16. The machine readable storage device of claim 15 wherein the domain classifier and shared component extractors are jointly trained to minimize a domain classification error with respect to the domain classifier while maximizing the domain classification error with respect to the shared component extractor.

17. A system comprising:
one or more processors; and
a storage device coupled to the one or more processors having instructions stored thereon to cause the one or more processors to execute speech recognition operations comprising:
receiving an unlabeled input speech frame;
using a shared component extractor to extract a shared component from the input speech frame;
using a speech unit classifier to identify a speech unit label from the shared component;
using a domain classifier to identify a speech unit label from the shared component;
using source/target private component extractors to extract source/target private components; and
using a reconstructor to reconstruct the original feature, wherein the shared component extractor, speech unit classifier, domain classifier, private component extractors and reconstructor are jointly optimized using stochastic gradient descent to adapt a labeled source domain acoustic model to an unlabeled target speech domain acoustic model to recognize speech from the unlabeled target speech domain.

18. The system of claim 17 wherein the shared component is made domain-invariant and senone or phoneme discriminative.

19. The system of claim 18 wherein the shared component is made domain-invariant by minimizing a domain classification error with respect to the domain classifier while maximizing the domain classification error with respect to the shared component extractor.

20. The system of claim 17 wherein the shared component extractor and speech unit classifier are initialized from a DNN-HMM acoustic model, the domain classifier, private component extractors and reconstructor and are jointly trained with labeled speech data (X^{s}, Y^{s}) from the source speech domain where X^{s}, are speech frames and Y^{s} are senone or phoneme labels, unlabeled speech data X^{s} from target speech domain and domain labels from both source and target domains, such that the shared component extractor and senone classifier form an adapted trained domain invariant acoustic model.
